(19) United States
(12) Patent Application Publication
(10) Pub. No.: US 2007/0089360 A1
(43) Pub. Date: Apr. 26, 2007

(54) Apparatus and method for irrigating christmas trees

(76) Inventor: Blake A. Koch, Simi Valley, CA (US)

Correspondence Address: ROBERT J. SCHAAP, Suite 188, 21241 Ventura Boulevard, Woodland Hills, CA, 91364, US

(21) Appl. No.: 11/255,629

(22) Filed: Oct. 21, 2005

(51) Int. Cl. A01G 27/02

(52) U.S. Cl. 47/40.5

(57) ABSTRACT

An apparatus and a method for irrigating Christmas trees which are retained in a planter or synthetic mounting pan, particularly during holiday and Christmas seasons. The apparatus relies upon a container of water which incorporates a small valve allowing water to be released from the container hung within the Christmas tree and drop the water into the planter, when the water level in the planter has evaporated to a certain level.

### BACKGROUND OF THE INVENTION

1. Field of the Invention

This invention relates in general to certain new and useful improvements in irrigation of cut Christmas trees, which are stem cut and upright mounted, and more particularly, to both a method and an apparatus which allows for irrigation of Christmas trees when water level in a container or planter in which the tree is mounted has evaporated or been withdrawn to a certain level.

2. Brief Description of Related Art

Christmas trees are commonly used in a variety of decorative activities, and particularly around the Christmas season, at least in many Christian communities. Typically, these trees are pine or spruce trees which have been cut and which would become dry and as a result become a fire hazard if not constantly irrigated.

It is very common to take these cut Christmas trees and mount them in stands. However, a Christmas tree does dry out fairly quickly, particularly if not mounted within a container of water. Accordingly, there are small conventional planters in which the tree is held and the planters will contain a small amount of water.

It is very common to hang electrical lights on Christmas trees, and although quite decorative, the tree also becomes a fire hazard if there is not a sufficient amount of water contained in the planter or container in which the tree is mounted. By ensuring that the tree has a sufficient source of water it does not dry out as quickly and, as a result, the fire hazard is substantially reduced.

Notwithstanding the risk of mounting lights on an unirrigated tree, users of these Christmas trees very frequently overlook the need to ensure that there is sufficient water in the container or planter in which the tree is mounted. As a result, and at very minimum, the trees begin to wither and dry out. More importantly, however, the trees do become that fire hazard. Once the tree has dried out, it is difficult for a cut tree to regenerate, and therefore, it may be necessary to discard the tree if sufficiently dried out.

It would, therefore, be desirable to provide some means to ensure that there was always water available at the base of the Christmas tree and in the container in which the Christmas tree is mounted.

### OBJECTS OF THE INVENTION

It is, therefore, one of the primary objects of the present invention to provide a means for irrigating a Christmas tree on a regular basis and which requires little or no periodic manual intervention by a user.

It is another object of the present invention to provide a device which allows for water to be released from a container mounted within the Christmas tree to the base of the Christmas tree when water at the base has been depleted.

It is a further object of the present invention to provide a device of the type stated which operates with a very simple valve so that it will automatically permit the release of water to the base of a Christmas tree when the device senses that there is an insufficient amount of water at the base of that tree.

It is an additional object of the present invention to provide an apparatus of the type stated which can be constructed at a very low unit cost and which is highly reliable in operation.

It is still another salient object of the present invention to provide a method of ensuring that water is present in the base of a Christmas tree without the constant visual examination by a user.

With the above and other objects in view, my invention resides in the novel features of form, construction, arrangement and combination of parts and components presently described and pointed out in the claims.

### BRIEF SUMMARY OF THE INVENTION

The present invention relates in general terms to an apparatus and a method which enable the watering of Christmas trees so as to ensure that there is a certain level of water within the base, in which the Christmas tree is mounted, at all times. This will, of course, preclude the drying out of the tree and reduce the possibility of the tree becoming a fire hazard.

The device of the present invention relies upon a container of water, such as, for example, a plastic bag of water, which can be mounted within the tree, itself, and on the tree trunk and hidden within the branches and leaves on the tree branches. A typical type of hospital waterproof bag used for intravenous administration to patients is highly effective for this purpose. The typical hospital type bag is also provided with a tube, such as a plastic tube, which extends from the bottom of that bag and allows liquid contained in the bag to be delivered through the plastic tube to a source thereof.

In accordance with the present invention, a hospital type bag can be mounted on the trunk of the Christmas tree and use a plastic tube which extends to a container in which the tree is mounted. In this way, water can be delivered from the bag to the container or base so that there is a sufficient amount of water in the base. In most cases, the water source will be mounted on the tree and preferably hidden in the tree. However, it is also possible to mount a source of water in close proximity to the tree, as for example, on a stand behind the tree, or otherwise, decoratively covered so as to potentially blend in with the tree. In either case, the term “close proximity” as used herein will refer to a source of water which is mounted on the tree or otherwise spaced from the tree, but in close proximity to the tree.

In order to automate the system, a simple control valve, such as a pinch-type valve mechanism, could be used so that a user can manually open and close that valve each day and thereby allow the delivery of a small quantity of water to the base each day. This would constitute a highly effective means to irrigate the Christmas tree. However, it is also possible to automate the delivery of the water to the base, at a relatively low cost, when water in the base has been depleted. In this case, a very basic type of sensor and feedback control loop is enabled through the use of a valve which would be responsive to a complete lack of water in the container.

It is also possible to provide a very low cost and highly effective automated irrigation system for a Christmas tree and which utilizes essentially the same components as those employed in the manually operable embodiment of the invention. In this automated system, there is provided a bottle or plastic bag containing water with an inlet spout for receiving water and a cap to close the spout. The lower end of the bottle is connected to a drain tube. A stop cock or a valve mechanism may be enclosed in the drain line, and the lower end of this drain line may be located at the bottom of the tray or pan in which the tree may be mounted.

In this case, water is introduced into the bottle and the cap sealingly enclosed over the spout. When water is first introduced, the valve or stop cock on the drain line is closed. Thereafter, the valve may be opened. The pressure created by the water will create a vacuum within the bottle which effectively holds the water in the bottle. However, when water has drained from or otherwise been consumed in the tray or pan, a larger vacuum will be created again to hold the remaining portion of the water within the bottle. This process will continue until all of the water in the bottle has been depleted.

In still a further embodiment of the invention, there is provided a valve mechanism which is automatically operable in response to the level of water in the tray holding the tree. A needle valve moves in and out with respect to a seat in response to the water level and this controls the distribution of water from a water source.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a somewhat schematic side elevational view of a Christmas tree with an irrigation system in accordance with the present invention used therewith;

FIG. 2 is a somewhat schematic side elevational view showing the details of the system of the invention;

FIG. 3 is a side elevational view, partially broken away, of a modified form of Christmas tree irrigation system in accordance with the present invention;

FIG. 4 is a schematic electrical control diagram for use with the water irrigation system of FIG. 3; and

FIG. 5 is a schematic elevational view of a further modified form of irrigation system for use with a Christmas tree in accordance with the present invention.

### DETAILED DESCRIPTION OF A PREFERRED EMBODIMENT

Referring now in more detail and by reference characters to the drawings, which illustrate preferred embodiments of the invention, 10 designates a Christmas tree, such as a pine or spruce tree, having a trunk 12 mounted within a stand or frame 14 for holding the Christmas tree in an upright position. The frame or stand is typically located in a pan 16 having an interior reservoir 18 with a level of water 20 therein.

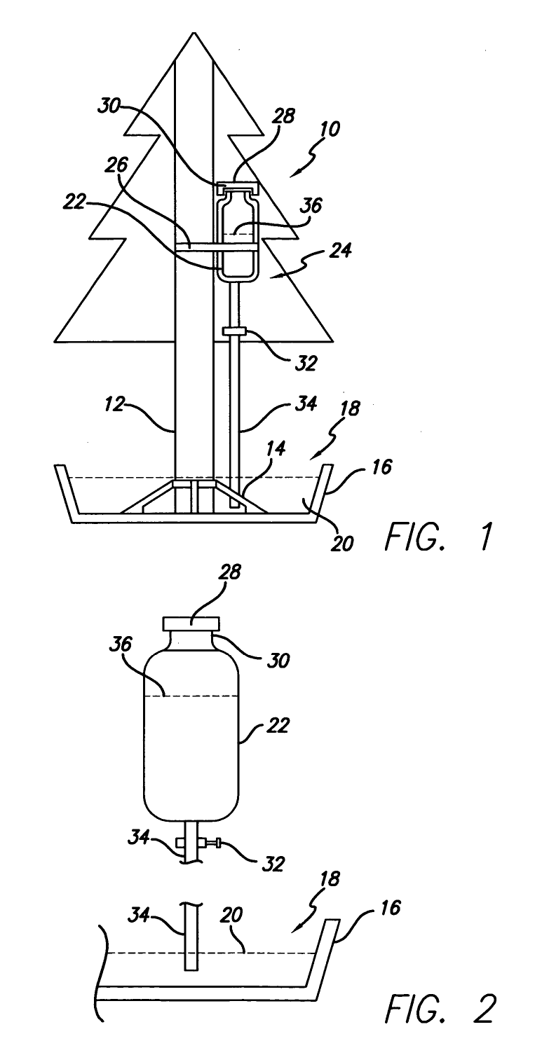

In the arrangement as shown in FIG. 1, it can be observed that the lower end of the trunk 12 is incorporated within this bath of water 20 and thereby enables the tree to remain in a moist condition and reduce the rate of die-out and decay. As indicated previously, not only does this increase the longevity of the tree, but it substantially reduces the possibility of fire hazard arising therefrom.

Mounted on the trunk of the tree 12 is a water bottle 22 forming part of the irrigation system of the invention 24. It can be seen that the water bottle 22 may be secured to the tree trunk 12 by any conventional means, as for example, a strap 26, such as a belt, or the like.

The water bottle 22 is provided with a removable cap 28 disposed over a spout 30 on the upper end of the water bottle. In this way, the cap 28 can be removed periodically for introducing water into the interior of the bottle 22 and, thereafter, replaced. It can be observed that there will be a need to replenish water in the tray 16 from time to time. This is due to the fact that the tree will actually absorb some of the water, and moreover, a substantial portion of the water will evaporate.

To initially prevent water in the bottle 22 from draining directly into the tray 16, a valve or stop cock 32 may be provided in a drain line 34 leading to the tray 16. This drain line 34 may adopt the form of a small diameter plastic tube which allows delivery of water from the bottle 22 at a slow rate. In this way, there will always be a vacuum maintained in the bottle 22, in a manner as hereinafter described in more detail.

When water is present in the tray 16, as for example, to the level 20 as shown, there will be no water withdrawn from the bottle 22. If the water level in the bottle 22 is at the position identified as 36, the area of the bottle 22 above the water line 36 will have a vacuum therein. This vacuum is maintained by the enclosure of the bottle and the cap 28 over the spout 30. This will preclude water from draining through the tube 34.

When water is depleted from the tray 16, and the level of water is below the lower end of the drain line 34, air will enter into the drain line and into the bottle 22. Hence, the area occupied by the vacuum will again have air introduced therein. As the air enters into the bottle, water will exit the bottle by the force of gravity into the tray 16. When a sufficient level of water has been withdrawn from the bottle into the tray 16, then further withdrawal of water will cause a vacuum again in the bottle 22 above the level of water 36 in that bottle 22. This vacuum will again hold the water in the bottle 22. This process can continue periodically and repetitively. Thus, as water is depleted in the tray 16, a portion of the water in the bottle will be introduced into the tray 16, but a vacuum will again be created, as previously described, thereby again retaining the remaining amount of water within the bottle 22.

As indicated previously, it is not absolutely necessary to mount the source of water directly on the tree, although this is the preferred arrangement. It is possible to have the water mounted perhaps on a shelf, or maybe a separate stand, which is located in the close vicinity of the tree. Thus, any mounting of the source of water so that it can deliver water to the base is sufficient and is deemed to be in close proximity to the tree.

It can be seen that the above-identified system is an automatic system, such that the user may only fill the water bottle on occasions when the latter has been emptied. The water will periodically drain from the water bottle 22 and into the tray 16 up to the level 20. Thereafter, the creation of the vacuum in the bottle 22 will again stop the drain of the remaining portion of the water by means of the vacuum which is created above the level of the water.

As indicated previously, the inner diameter of the tube is sufficiently small so that there will not be a rush of water draining from the bottle. It should also be understood that other types of feedback systems could be used. Although the water control system as described herein is effective, and available at a very low cost, it should understood that the invention contemplates a more robust servo system, which can be used. Thus, a sensor could be incorporated in the tray in order to determine the level of water which will control a feedback loop to a valve operable with the bottle. Although this type of embodiment is contemplated, and can even be used with trees in commercial or industrial establishments, the use of the very low cost vacuum system described herein is highly effective for trees mounted in a residential environment.

It is, however, also possible to use a manually operable system in accordance with the present invention. This manually operable system uses essentially the same components. However, in this case, the cap 28 on the bottle is not tightly secured to the spout 30. Rather, and in this case, as water is drained from the bottle 22, air will enter the upper end of the spout 30 and into the water bottle. This will preclude the formation of a vacuum at the upper end of the bottle and allow all of the water to drain into the tray 16. However, in a manual operation of the irrigation system, the user will control the stop cock or valve 32. Thus, for users who will visually monitor the level of water in the tray 16 on a periodic basis, the manually operable system is also highly effective.

FIG. 3 illustrates a more sophisticated, but nevertheless, low cost system for controlling delivery of water to a tree. In this embodiment, like reference numerals will be used to identify like components in the embodiment of FIGS. 1 and 2.

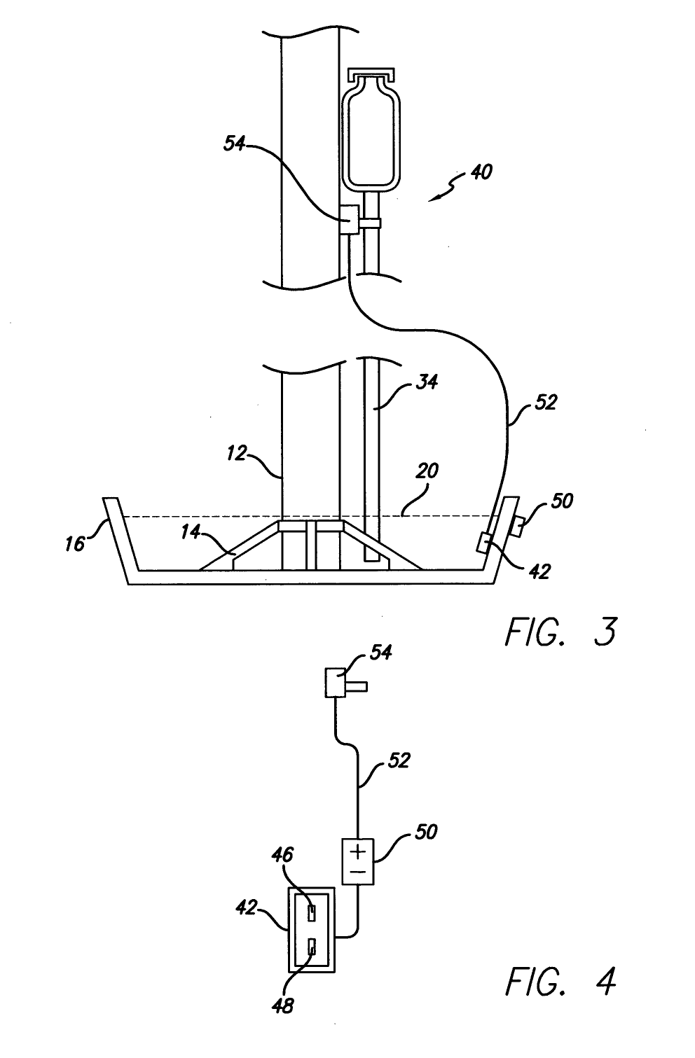

The Christmas tree water irrigation system 40 of the invention, as more fully illustrated in FIGS. 3 and 4, also includes a tree trunk 12 retained suitably within a framework 14, and the latter being disposed within a tray 16. In like manner, water will be disposed in the tray to the level 20, as shown in FIG. 3. In this embodiment, there is provided a very low cost sensor 42 which determines whether or not there is sufficient water within the tray 16. In this case, the sensor can be a very rudimentary, but yet a sufficiently operable, sensor which is capable of detecting the level of water.

Referring to FIG. 4, it can be seen that the sensor has a pair of electrodes 46 and 48 when one of which is connected to a battery source of power 50. The water in the tray can operate as a ground. The battery source of power would be connected directly through an insulated electrical conductor 52 directly to a low cost control valve 54. Thus, when water is in the tray 16 to a sufficient level, the circuit arrangement will cause the control valve 54 to remain closed and thereby preclude the delivery of water through the tube 34 into the tray 16.

However, it can be observed, by reference to FIG. 4, that when water falls beneath the level of the upper electrode 46, there will no longer be a complete circuit connection between the electrode 46 and the electrode 48. This will cause a disruption of power to the control valve 54 allowing the latter to open. When this occurs, water in the bottle 22 will then drain through the drain line 34 and into the tray 16.

This embodiment of the invention is obviously more sophisticated than that previously described. However, it is still a low cost, but nevertheless effective, water control system used in the Christmas tree irrigation system of the invention.

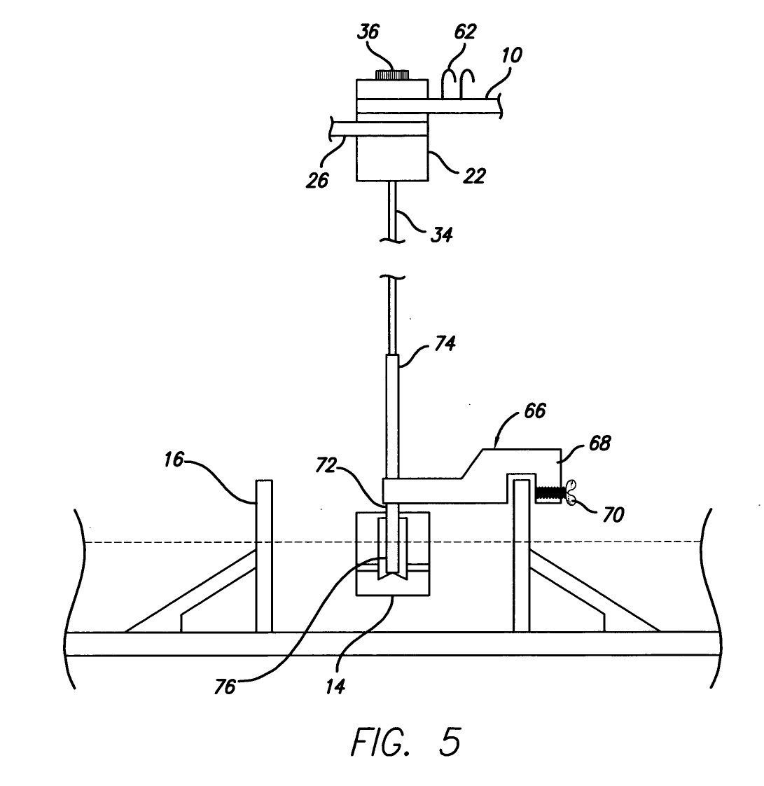

It is also possible to provide an irrigation system for Christmas trees of the type more fully illustrated in FIG. 5 of the drawings. In this case, there is a water bottle 22 which would be adapted for mounting on a Christmas tree, much in the same manner as previously described, as for example, by means of a belt 26. The water bottle is also provided with a delivery stem, such as the delivery stem 34. It also includes a filler cap 36, as shown. In this case, the water bottle could be retained by means of a bracket 60 mounted on the bottle and having outwardly extending hooks 62 for disposition over a branch of the tree trunk.

Connected to the lower end of the tube 34 is a dispensing valve mechanism 66, which similarly includes a bracket 68 mountable on the tray 16 or similar structure for holding the Christmas tree. A wingnut mechanism 70 may be provided for securement to the tray 16. A needle mechanism 72 moves in a holder 74 and controls the flow of water through a seat device 74 having a channel 76 for receiving the needle 72 and a seat 78.

In the embodiment of the invention as illustrated, it can be observed that water is carried through the needle 72 and can enter into the tray through outlets 78 if the needle is not blocked. If the water level is sufficiently high, such that the seat mechanism 74 is biased upwardly, that upper force on the mechanism 74 will cause the valve plug 82 to close off the lower end of the needle valve 72. If, in fact, the valve is opened, water can flow into the tray through the outlets 78.

The device, as illustrated in FIG. 5, is another alternate embodiment which allows for automatic dispensing of water directly into the tray. This embodiment, along with the previous embodiments, as illustrated and described, are only representative of several embodiments which could be presented for providing for automatic filling of the tray, or, for that matter, for the manual filling of the tray, also as previously described.

Thus, there has been illustrated and described a unique and novel apparatus and method for irrigating Christmas trees and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1. Irrigating system for a cut Christmas tree supported in a water receiving member to preclude premature drying of said tree, said irrigating system comprising:
a) a receiving means for receiving and holding said tree
b) a source of water;
c) means for mounting said source of water in close proximity to said tree;
d) tube means allowing for a draining of water from said source to said receiving means; and
e) means for controlling the flow of water from said source to avoid excess water in said receiving member.

2. The irrigation system for a cut Christmas tree of claim 1 further characterized in that:
a) the means for controlling the flow of water is located in said tube means and is manually controllable.

3. The irrigation system for a cut Christmas tree of claim 1 further characterized in that:
a) the means for controlling the flow of water is a valve means responsive to the level of water in the receiving means.

4. The irrigation system for a cut Christmas tree of claim 3 further characterized in that:
a) the valve means is responsive to an electrical switch means.

5. The irrigation system for a cut Christmas tree of claim 3 further characterized in that:
a) the valve means is responsive to a vacuum in said source and an introduction of air into said source to deplete the vacuum.

6. The irrigation system for a cut Christmas tree of claim 3 further characterized in that:
a) the valve means is operable with a needle valve and a seat which is buoyant with respect to the needle valve.

7. The irrigation system for a cut Christmas tree of claim 2 further characterized in that the source of water comprises:
a) a container of water with a fill spout for introducing water into the source and that said spout allows for an introduction of air into said source of water.

8. The irrigation system for a cut Christmas tree of claim 3 further characterized in that the source of water comprises:
a) a container of the water with a fill spout for introduction of water into the source and the spout is sealed in operation of the irrigation system.

9. The irrigation system for a cut Christmas tree of claim 1 further characterized in that the source of water is mounted on the tree.

10. A method for irrigating a cut Christmas tree to preclude premature drying of said tree, said method comprising:
a) filling a portable source of water with water;
b) securing the portable source of water with respect to said tree; and
c) controlling delivery of water to a receiving member in which said tree is mounted.

11. A method for irrigating a cut Christmas trees of claim 10 further characterized in that the method comprises:
a) locating a tube from said source to said receiving member in which said tree is mounted and causing water from the source to be delivered to the receiving member.

12. A method for irrigating a cut Christmas trees of claim 10 further characterized in that the method comprises:
a) locating a valve means with respect to said tube; and
b) manually controlling said valve means.

13. A method for irrigating a cut Christmas trees of claim 10 further characterized in that the method comprises:
a) locating a valve means with respect to said tube;
b) automatically controlling said valve means.

14. An apparatus for providing water to the base of a cut and mounted Christmas tree so as to sustain the life of the Christmas tree and maintain the health thereof, said apparatus comprising:
a) a container of water adapted for mounted disposition within the tree;
b) tube means extending from the bases of its container and allowing water in the container to be released to a base in which the Christmas tree is mounted; and
c) valve means located in said tube and capable of being opened to allow water in the container to be released to a base in which the tree is mounted and thereby provide a source of water at the base of the tree.
